(19) United States
(12) Patent Application Publication
(10) Pub. No.: US 2025/0056155 A1
(43) Pub. Date: Feb. 13, 2025

(54) ACOUSTIC LENS AND LOUDSPEAKER SYSTEM

(71) Applicant: Panasonic Intellectual Property Management Co., Ltd., Osaka (JP)

(72) Inventors: Kota NAKAHASHI, Osaka (JP); Shuji SAIKI, Nara (JP); Akihisa KAWAMURA, Osaka (JP); Satoshi TAKAYAMA, Mie (JP)

(21) Appl. No.: 18/930,071

(22) Filed: Oct. 29, 2024

Related U.S. Application Data
(63) Continuation of application No. PCT/JP2023/017255, filed on May 8, 2023.
(60) Provisional application No. 63/340,653, filed on May 11, 2022.

(30) Foreign Application Priority Data
Apr. 27, 2023 (JP) 2023-073692

(51) Int. Cl. H04R 1/34

(52) U.S. Cl. CPC H04R 1/345

(57) ABSTRACT

An acoustic lens includes: a plurality of first partition plates aligned apart from each other in the traveling direction of sound waves to be emitted from a loudspeaker. Each of the plurality of first partition plates includes holes through which the sound waves pass. The lengths of the plurality of first partition plates in a first direction are mutually different.

### CROSS REFERENCE TO RELATED APPLICATIONS

This is a continuation application of PCT International Application No. PCT/JP2023/017255 filed on May 8, 2023, designating the United States of America, which is based on and claims priority of Japanese Patent Application No. 2023-073692 filed on Apr. 27, 2023 and U.S. Provisional Patent Application No. 63/340,653 filed on May 11, 2022. The entire disclosures of the above-identified applications, including the specifications, drawings and claims are incorporated herein by reference in their entirety.

### FIELD

The present invention relates to an acoustic lens that controls sound directivity, and a loudspeaker system.

### BACKGROUND

Patent Literature (PTL) 1 discloses an acoustic lens that improves the directivity of sound waves from a parallel travelling wave to a spherical wave.

### CITATION LIST

Patent Literature

[PTL 1] Japanese Unexamined Utility Model Application Publication No. S55-155179

### SUMMARY

### Technical Problem

The present disclosure aims to provide an acoustic lens, etc., that can easily control the directivity of sound waves.

### Solution to Problem

An acoustic lens according to one aspect of the present disclosure includes a plurality of first partition plates aligned apart from each other in the traveling direction of a sound wave to be emitted from a loudspeaker. Each of the plurality of first partition plates includes holes through which the sound wave passes. The lengths of the plurality of first partition plates in a first direction are mutually different.

A loudspeaker system according to one aspect of the present disclosure includes the acoustic lens and the loudspeaker that emits the sound wave to the acoustic lens.

### Advantageous Effects

The acoustic lens according to the present disclosure has an advantage that the directivity of sound waves is easily controlled.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is an overview diagram illustrating a loudspeaker system according to a comparative example.

FIG. 2 is an overview diagram illustrating a usage example of a loudspeaker system including an acoustic lens according to an embodiment.

FIG. 3 is an overview diagram illustrating the configuration of the acoustic lens according to the embodiment.

FIG. 4 is an illustration of directivity of the acoustic lens according to the embodiment.

FIG. 5 is an overview diagram illustrating the configuration of an acoustic lens according to Variation 1 of the embodiment.

FIG. 6 is an overview diagram illustrating the configuration of an acoustic lens according to Variation 2 of the embodiment.

FIG. 7 is an illustration of directivity of the acoustic lens according to Variation 2 of the embodiment.

FIG. 8 is an overview diagram illustrating the configuration of an acoustic lens according to Variation 3 of the embodiment.

### DESCRIPTION OF EMBODIMENTS

### Underlying Knowledge Forming Basis of the Present Disclosure

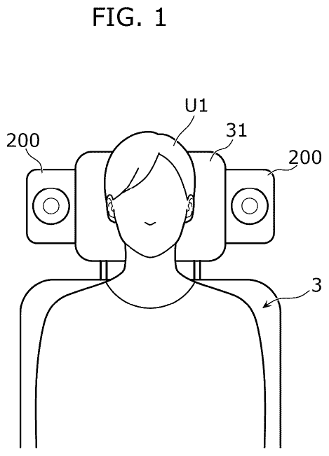

A conventional loudspeaker system that is provided in a seat in a moving body such as a vehicle, an aircraft, or a train, and reproduces, for instance, sounds or music for a user seated on the seat is known. FIG. 1 is an overview diagram illustrating loudspeaker system 200 according to a comparative example. Loudspeaker system 200 according to the comparative example is provided in headrest 31 of seat 3. In the example in FIG. 1, loudspeaker system 200 according to the comparative example is provided in the vicinity of the left ear and in the vicinity of the right ear of user U1 seated on seat 3.

With loudspeaker system 200 according to the comparative example, the directivity of sound waves emitted from a loudspeaker is uniform with respect to the front direction of the loudspeaker. Therefore, with loudspeaker system 200 according to the comparative example, sounds or music reproduced by the loudspeaker is likely to leak to a person seated on the seat next to seat 3 and a person seated on the seat behind seat 3. In other words, with loudspeaker system 200 according to the comparative example, there is a problem that sounds are likely to leak to a person other than target user U1.

In view of the above, the present disclosure aims to provide an acoustic lens that can easily control sounds that leak to a person other than target user U1, by devising the structure of an acoustic lens to easily control the directivity of sound waves.

More specifically, the acoustic lens according to a first aspect of the present disclosure includes a plurality of first partition plates aligned apart from each other in the traveling direction of a sound wave to be emitted from a loudspeaker. Each of the plurality of first partition plates includes holes through which the sound wave passes. The lengths of the plurality of first partition plates in a first direction are mutually different.

This provides an advantage that the directivity of sound waves is easily controlled since the lengths of paths through which the sound waves pass can be adjusted according to the number of holes through which the sound waves pass in the first direction.

For example, in the acoustic lens according to a second aspect of the present disclosure, in the first aspect, the plurality of first partition plates are disposed such that the total number of the plurality of first partition plates that overlap in the traveling direction of the sound wave monotonically decreases from one end of the plurality of first partition plates to the other end in the first direction.

This provides an advantage that it is easy to control on which side of the first direction the directivity of sound waves is to be set.

For example, in the first or second aspect, the acoustic lens according to a third aspect of the present disclosure further includes a plurality of second partition plates that overlap the plurality of first partition plates in the traveling direction of the sound wave and are aligned apart from each other. Each of the plurality of second partition plates has holes through which the sound wave passes. The lengths of the plurality of second partition plates in a second direction are mutually different, where the second direction intersects the first direction.

With this, since the directivity of sound waves in the first direction is controlled by the plurality of first partition plates and the directivity of the sound waves in the second direction is controlled by the plurality of second partition plates, there is an advantage that the directivity of the sound waves in each of two directions intersecting each other is easily controlled.

For example, in the acoustic lens according to a fourth aspect of the present disclosure, in the third aspect, the plurality of second partition plates are disposed such that the total number of the plurality of second partition plates that overlap monotonically decreases in the traveling direction of the sound wave with increasing distance from the center of the plurality of second partition plates along the second direction.

This provides an advantage that it is easy to set the directivity of sound waves closer to the center of the plurality of second partition plates along the second direction.

For example, in the acoustic lens according to a fifth aspect of the present disclosure, in the third or fourth aspect, the first direction and the second direction are orthogonal to each other.

This provides an advantage that with the first direction defined as a horizontal direction and the second direction defined as a vertical direction, the directivity of sound waves in each of the horizontal direction and the vertical direction is easily controlled.

For example, in the acoustic lens according to a sixth aspect of the present disclosure, in any one of the first to fifth aspect, the diameters of the holes decrease in the traveling direction of the sound wave with increasing distance from the loudspeaker.

This provides an advantage that the directivity of sound waves is likely to be sharp since the lengths of paths through which the sound waves pass increase more as the number of holes through which the sound waves pass increases, compared with when the diameters of the holes are same.

For example, in the acoustic lens according to a seventh aspect of the present disclosure, in any one of the first to sixth aspects, at least one or more of the holes do not overlap each other in the traveling direction of the sound wave.

This provides an advantage that the directivity of sound waves is likely to be sharp since the lengths of paths through which the sound waves pass can be increased, compared with when holes overlap each other in the traveling direction of the sound waves.

For example, a loudspeaker system according to an eighth aspect of the present disclosure includes: the acoustic lens according to any one of the first to seventh aspects; and the loudspeaker that emits the sound wave to the acoustic lens.

This provides an advantage that the same advantageous effects as produced by the aforementioned acoustic lens can be produced.

Hereinafter, embodiments of the present disclosure will be described with reference to the drawings. The embodiments described below each illustrate a general or specific example of the present disclosure. The numerical values, shapes, materials, elements, the arrangement positions and connections of the elements, steps, order of the steps, etc., shown in the following embodiments are mere examples, and therefore do not intend to limit the present disclosure. Geometric expressions such as “parallel” and “orthogonal” are used in some cases, but these expressions each do not present a mathematical strictness and include a difference or deviation that is substantially allowed. For example, in the following description, when an angle between two directions intersecting each other is 90 degrees plus or minus 1% to 5%, it can be said that these two directions are orthogonal. Moreover, an expression “at the same time” or “same” also includes a range that is substantially allowed.

Among elements in the following embodiments, elements not described in independent claims are illustrated as optional elements. The figures are schematic diagrams and are not necessarily precise illustrations. Elements that are essentially the same share like reference signs in the figures, and duplicate description may be omitted or simplified.

### Embodiment

### 1. Configuration

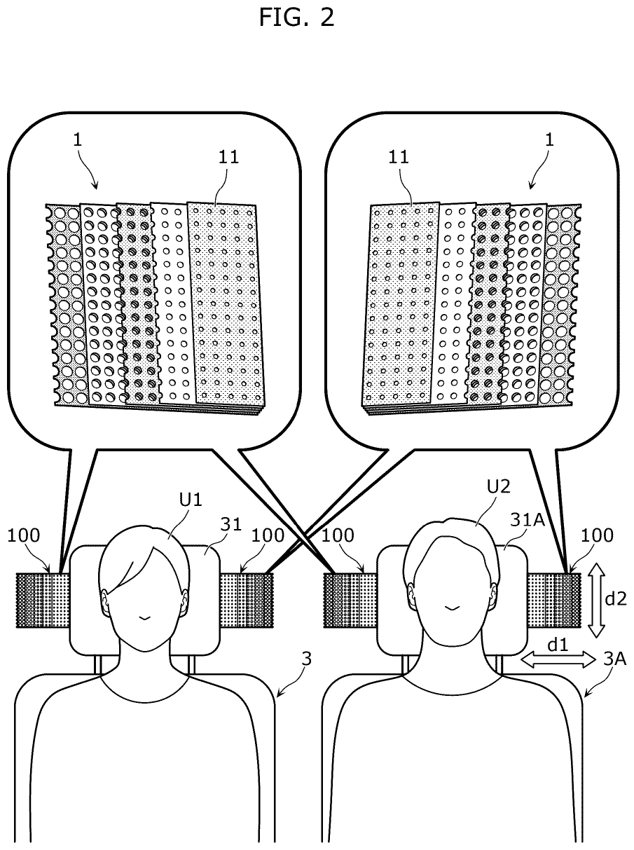

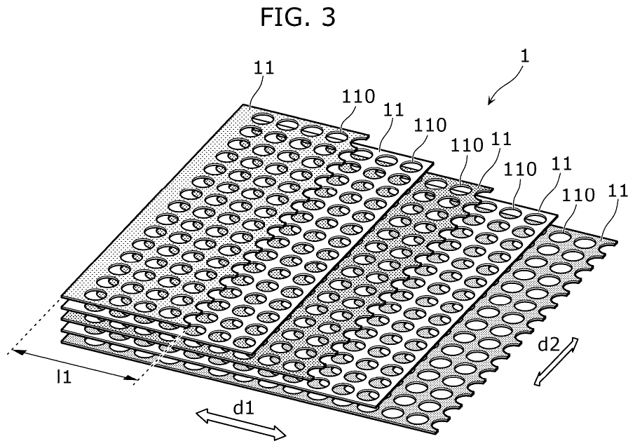

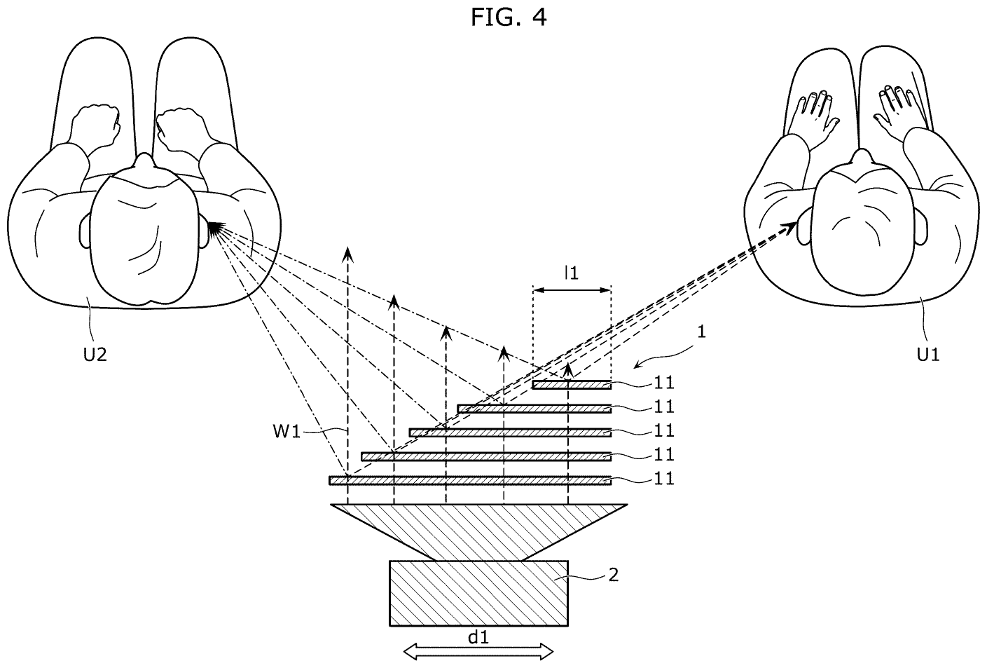

Hereinafter, acoustic lens 1 according to an embodiment and loudspeaker system 100 including acoustic lens 1 will be described. FIG. 2 is an overview diagram illustrating a usage example of loudspeaker system 100 including acoustic lens 1 according to the embodiment. In FIG. 2, the indication of loudspeaker 2 is omitted. FIG. 3 is an overview diagram illustrating the configuration of acoustic lens 1 according to the embodiment. FIG. 3 is an overview diagram illustrating the configuration of acoustic lens 1 according to the embodiment. FIG. 4 is an illustration of directivity of acoustic lens 1 according to the embodiment.

As illustrated in FIG. 2, loudspeaker system 100 includes acoustic lens 1 and loudspeaker 2 (see FIG. 4). Loudspeaker system 100 is a system for allowing target user U1 to hear the sounds of sound waves W1 (see FIG. 4) emitted from loudspeaker 2 via acoustic lens 1.

In the embodiment, loudspeaker systems 100 are provided in each of seats 3 and 3A in a moving body such as a vehicle. Hereinafter, the following describes assuming that seat 3 is a driver's seat in a vehicle and seat 3A is a passenger's seat in the vehicle. Seats 3 and 3A are aligned in the right-left direction (horizontal direction) of the vehicle on the front side of the vehicle. The following describes assuming that the right-left direction (horizontal direction) of the vehicle is “first direction d1” and the height direction (vertical direction) of the vehicle is “second direction d2”, unless otherwise specified.

Loudspeaker system 100 is provided at each of both ends of headrest 31 of seat 3 in first direction d1. In other words, loudspeaker system 100 is provided in the vicinity of the left ear and in the vicinity of the right ear of user U1 seated on seat 3. Loudspeaker system 100 is provided also at both ends of headrest 31A of seat 3A in first direction d1. In other words, loudspeaker system 100 is provided in the vicinity of the left ear and in the vicinity of the right ear of user U2 seated on seat 3A.

Loudspeaker 2 is a device that outputs sound waves W1 by converting the electric signals of, for instance, sound signals into vibrations of a vibration board. The size, shape, and structure of the vibration board, a magnetic circuit, a frame, or the like included in loudspeaker 2 are not specifically limited. In the embodiment, loudspeaker 2 is an electrodynamic loudspeaker including a cone diaphragm. Loudspeaker 2 emits sound waves W1 to acoustic lens 1. With this, sound waves W1 emitted from loudspeaker 2 pass through acoustic lens 1 and are emitted to outside (to the air).

As illustrated in FIG. 3, acoustic lens 1 includes a plurality of first partition plates 11 (five in this case). Each first partition plate 11 is a member that is like a flat plate, and first partition plate 11 itself does not vibrate easily. A material included in each first partition plate 11 is, for example, wood, resin, metal, or ceramic, and is not specifically limited.

The plurality of first partition plates 11 are disposed aligned apart from each other in the traveling direction of sound waves W1 emitted from loudspeaker 2, as illustrated in FIG. 3 and FIG. 4. Each first partition plate 11 may be supported by, for example, a frame-like member provided at the outer edge of first partition plate 11 or supported by a spacer provided between neighboring first partition plates 11, although not shown in the figures.

The term “the traveling direction of sound waves W1” used herein is the traveling direction of sound waves W1 emitted from loudspeaker 2 and is not the traveling direction of sound waves W1 passing through acoustic lens 1. In the embodiment, the traveling direction of sound waves W1 corresponds to a direction orthogonal to both first direction d1 and second direction d2.

As has already been described above, in the embodiment, first direction d1 is the horizontal direction and second direction d2 is the vertical direction. Accordingly, in the embodiment, first direction d1 and second direction d2 are orthogonal to each other. Note that first direction d1 and second direction d2 need to intersect each other and need not be orthogonal to each other.

As illustrated in FIG. 3, each of the plurality of first partition plates 11 has holes 110 through which sound waves W1 pass. In the embodiment, hole 110 is circular in shape in plan view (i.e., when viewed along the traveling direction of sound waves W1), and penetrates first partition plate 11 in the thickness direction of first partition plate 11 (i.e., the traveling direction of sound waves W1). In the embodiment, m holes 110 are provided aligned in first direction d1 and n holes 110 are provided aligned in second direction d2, where m and n are natural numbers.

Here, “m” may change according to the length of first partition plate 11 in first direction d1, and “n” may change according to the length of first partition plate 11 in second direction d2. In the embodiment, since the lengths of the plurality of first partition plates 11 are mutually different, the number of holes 110 aligned in first direction d1 in first partition plate 11 is different from one first partition plate 11 to another partition plate 11, as will be described later. In contrast, since the lengths of the plurality of first partition plates 11 in second direction d2 are same, the number of holes 110 aligned in second direction d2 in first partition plate 11 is same among the plurality of first partition plates 11.

In the embodiment, lengths l1 of the plurality of first partition plates 11 in first direction d1 are mutually different, as illustrated in FIG. 3. Here, first direction d1 is a direction in which the directivity of sound waves W1 is controlled. The plurality of first partition plates 11 are disposed such that the number of the plurality of first partition plates 11 that overlap in the traveling direction of sound waves W1 monotonically decreases from one end of the plurality of first partition plates 11 (the left side in FIG. 3) to the other end (the right side in FIG. 3) in first direction d1. Stated differently, the plurality of first partition plates 11 are disposed such that the number of the plurality of first partition plates 11 that overlap in the traveling direction of sound waves W1 monotonically decreases toward one end of the plurality of first partition plates 11 in first direction d1 closer to the directivity of sound waves W1 that is desired to be set. In other words, the plurality of first partition plates 11 are disposed so that lengths l1 of the plurality of first partition plates 11 increase toward loudspeaker 2 in the traveling direction of sound waves W1. That is to say, among the plurality of first partition plates 11, length l1 of first partition plate 11 in first direction d1 located farthest from loudspeaker 2 is the shortest and length l1 of first partition plate 11 in first direction d1 located closest to loudspeaker 2 is the longest.

Here, the directivity control of sound waves W1 in first direction d1 will be described with reference to FIG. 4. In FIG. 4, the illustration of holes 110 is omitted. In FIG. 4, sound waves W1 that pass through first partition plate 11 actually pass through holes 110 in first partition plate 11. As illustrated in FIG. 4, sound waves W1 pass through holes 110 in each first partition plate 11 and are emitted to outside (to the air).

As illustrated in FIG. 4, in acoustic lens 1, the directivity of sound waves W1 in first direction d1 is controlled by changing the lengths of paths through which sound waves W1 pass.

Specifically, the lengths of the paths of sound waves W1 that are emitted from loudspeaker 2 and reach the ear of user U2 seated on seat 3A increase as the number of first partition plates 11 that overlap is large, i.e., as first partition plates 11 are located closer to one end of first partition plates 11 in first direction d1 (the right side in FIG. 4), as indicated by dashed-dotted lines. Accordingly, a difference between the length of the path of sound wave W1 at one end of first partition plates 11 in first direction d1 and the length of the path of sound wave W1 at an end of first partition plates 11 where the number of first partition plates 11 that overlap is small, i.e., at the other end of first partition plates 11 in first direction d1 (the left side in FIG. 4) increases, a difference between arrival times of sound waves W1 that reach the ear of user U2 increases, and this increases the negation of sound waves W1.

In contrast, since user U1 is located on one side of first direction d1 where the number of first partition plates 11 that overlap is large, the overlap of first partition plates 11 hardly affects the paths of sound waves W1 that are emitted from loudspeaker 2 and reach the ear of user U1 seated on seat 3, as indicated by broken lines. Accordingly, there is almost no difference between the length of the path of sound wave W1 at one end of first partition plates 11 in first direction d1 and the length of the path of sound wave W1 at the other end of first partition plates 11 in first direction d1, a difference between arrival times of sound waves W1 that reach the ear of user U1 is small, and there is less influence caused by the negation of sound waves W1.

Accordingly, since the sound pressure level of sound waves W1 that reach the ear of user U2 is suppressed more than the sound pressure level of sound waves W1 that reach the ear of user U1, the directivity of sound waves W1 is directed toward one side of first direction d1.

### 2. Advantages

Hereinafter, advantages of acoustic lens 1 and loudspeaker system 100 according to the embodiment will be described. As described above, in acoustic lens 1 according to the embodiment, the lengths, in first direction d1, of the plurality of first partition plates 11 aligned apart from each other in the traveling direction are mutually different. Accordingly, with acoustic lens 1 according to the embodiment, since the lengths of paths through which sound waves 1 pass can be adjusted according to the number of holes 110 through which sound waves W1 pass, it is easy to control the directivity of sound waves W1 (directivity of sound waves W1 in first direction d1 in this case).

In the embodiment, with first direction d1 defined as a horizontal direction, acoustic lens 1 is capable of controlling the directivity of sound waves W1 in the horizontal direction. Acoustic lens 1 and loudspeaker system 100 that uses acoustic lens 1 may overcome the problems loudspeaker system 200 according to the comparative example has.

For example, loudspeaker system 100 is provided in the vicinity of the left ear and in the vicinity of the right ear of user U1 seated on seat 3, and acoustic lens 1 is placed so that the directivity of sound waves W1 is directed toward user U1 in the horizontal direction (first direction d1), as illustrated in FIG. 2. In this case, sound waves W1 emitted from loudspeaker 2 are emitted via acoustic lens 1 so that the directivity of sound waves W1 is directed toward user U1 in the horizontal direction, sounds are unlikely to leak to user U2 seated on seat 3A next to seat 3.

Likewise, loudspeaker system 100 is provided in the vicinity of the left ear and in the vicinity of the right ear of user U2 seated on seat 3A next to seat 3, and acoustic lens 1 is placed so that the directivity of sound waves W1 is directed toward user U2 in the horizontal direction (first direction d1). In this case, since sound waves W1 emitted from loudspeaker 2 are emitted via acoustic lens 1 so that the directivity of sound waves W1 is directed toward user U2 in the horizontal direction, sounds are unlikely to leak to user U1 seated on seat 3.

As described above, acoustic lens 1 according to the embodiment and loudspeaker system 100 that uses acoustic lens 1 provides an advantage that sounds that leak to a person other than target user U1 (or user U2) is easily suppressed.

### Other Embodiments

Although the acoustic lens and the loudspeaker system have been described above based on the embodiment, the present disclosure is not limited to the embodiment.

### Variation 1

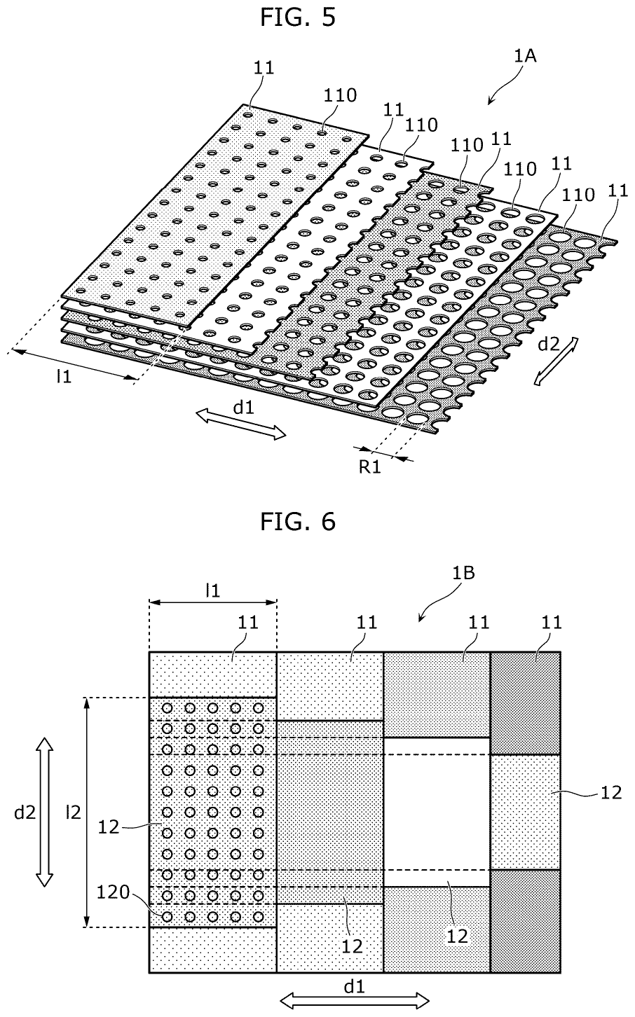

FIG. 5 is an overview diagram illustrating the configuration of acoustic lens 1A according to Variation 1 of the embodiment. Acoustic lens 1A according to Variation 1 is different from acoustic lens 1 according to the embodiment in that diameters R1 of holes 110 decrease with increasing distance from loudspeaker 2 in the traveling direction of sound waves W1 (stated differently, the thickness direction of first partition plates 11).

Specifically, diameter R1 of each hole 110 in first partition plate 11 located closest to loudspeaker 2 in the traveling direction of sound waves W1 is the largest and diameter R1 of each hole 110 in first partition plate 11 located farthest from loudspeaker 2 in the traveling direction of sound waves W1 is the smallest. A ratio of the total area of holes 110 to the area of first partition plate 11 in any first partition plate 11 is defined as an opening ratio. It therefore can be said that in acoustic lens 1A according to Variation 1, the opening ratios of the plurality of first partition plates 11 decrease with increasing distance from loudspeaker 2.

As described above, in acoustic lens 1A according to Variation 1, the opening ratios of the plurality of first partition plates 11 decrease with increasing distance from loudspeaker 2 in the traveling direction of sound waves W1. Therefore, the lengths of paths through which sound waves W1 pass increase as the number of holes through which sound waves W1 pass increases. Accordingly, acoustic lens 1A according to Variation 1, as compared with acoustic lens 1 according to the embodiment, provides an advantage that the directivity of sound waves W1 is controlled to be directed toward one side of first direction d1 (the left side in FIG. 5) and the directivity of sound waves W1 is likely to be sharp.

### Variation 2

FIG. 6 is an overview diagram illustrating the configuration of acoustic lens 1B according to Variation 2 of the embodiment. Acoustic lens 1B according to Variation 2 is different from acoustic lens 1 according to the embodiment in regard to the additional inclusion of a plurality of second partition plates 12.

Each second partition plate 12 is a member that is like a flat plate, and second partition plate 12 itself does not vibrate easily. A material included in each second partition plate 12 is, for example, wood, resin, metal, or ceramic, and is not specifically limited. The plurality of second partition plates 12 are disposed to overlap the plurality of first partition plates 11 in the traveling direction of sound waves W1 and are aligned apart from each other, as illustrated in FIG. 6. Specifically, the plurality of second partition plates 12 are disposed so that the plurality of first partition plates 11 and the plurality of second partition plates 12 are alternately aligned apart from each other in the traveling direction of sound waves W1. Each second partition plate 12, like each first partition plate 11, may be supported by, for example, a frame-like member or spacer not shown in the figure.

Each of the plurality of second partition plates 12 includes holes 120 through which sound waves W1 pass, as illustrated in FIG. 6. In FIG. 6, only holes 120 in second partition plate 12 located closest to loudspeaker 2 in the traveling direction of sound waves W1 (stated differently, the thickness direction of second partition plates 12) are illustrated, and the illustration of holes 120 in other second partition plates 12 is omitted. In FIG. 6, the illustration of holes 110 in each first partition plate 11 is also omitted.

In Variation 2, hole 120 is circular in shape in plan view (i.e., when viewed along the traveling direction of sound waves W1), and penetrates second partition plate 12 in the thickness direction of second partition plate 12 (i.e., the traveling direction of sound waves W1). In Variation 2, p holes 120 are provided aligned in first direction d1 and q holes are provided aligned in second direction d2, where p and q are natural numbers.

Here, “p” may change according to the length of second partition plate 12 in first direction d1 and “q” may change according to the length of second partition plate 12 in second direction d2. In Variation 2, since the lengths of the plurality of second partition plates 12 in first direction d1 are mutually different and the lengths of the plurality of second partition plates 12 in second direction d2 are mutually different, the number of holes 120 aligned in first direction d1 in second partition plate 12 is different from one second partition plate 12 to another second partition plate 12, and the number of holes 120 aligned in second direction d2 is also different from one second partition plate 12 to another second partition plate 12.

In Variation 2, lengths l1 of the plurality of second partition plates 12 in first direction d1 are mutually different, as illustrated in FIG. 6. In addition, lengths l2 of the plurality of second partition plates 12 in second direction d2 intersecting first direction d1 are mutually different. Here, second direction d2, like first direction d1, is a direction in which the directivity of sound waves W1 is controlled. The plurality of second partition plates 12 are disposed such that the number of the plurality of second partition plates 12 that overlap in the traveling direction of sound waves W1 monotonically decreases with increasing distance from the center of the plurality of second partition plates 12 along second direction d2. Stated differently, the plurality of second partition plates 12 are disposed such that the number of the plurality of second partition plates 12 that overlap in the traveling direction of sound waves W1 monotonically increases toward one end of the plurality of second partition plates 12 along second direction d2 closer to the directivity of sound waves W1 that is desired to be set. In other words, the plurality of second partition plates 12 are disposed so that lengths l2 of the plurality of second partition plates 12 in second direction d2 decrease toward loudspeaker 2 in the traveling direction of sound waves W1. That is to say, among the plurality of second partition plates 12, length l2 of second partition plate 12 in second direction d2 that is located closest to loudspeaker 2 in the traveling direction of sound waves W1 is the longest and length l2 of second partition plate 12 in second direction d2 that is located farthest from loudspeaker 2 is the shortest.

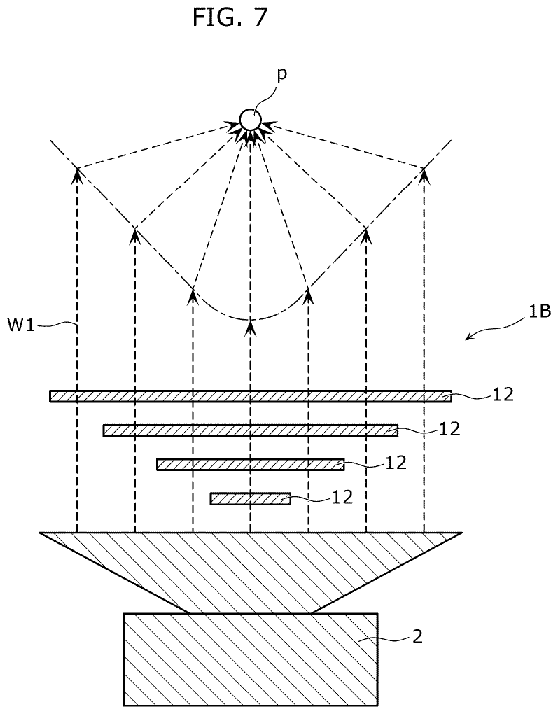

Directivity control of sound waves W1 in second direction d2 by acoustic lens 1B according to Variation 2 will be described with reference to FIG. 7. FIG. 7 is an illustration of directivity in acoustic lens 1B according to Variation 2 of the embodiment. In FIG. 7, the illustration of first partition plates 11 and the illustration of holes 120 in each second partition plate 12 are omitted. In FIG. 7, sound waves W1 that pass through each second partition plate 12 actually pass through holes 110 in each first partition plate 11 and holes 120 in each second partition plate 12.

As illustrated in FIG. 7, in acoustic lens 1B, the directivity of sound waves W1 in second direction d2 is controlled by changing the lengths of paths through which sound waves W1 pass.

Specifically, the lengths of paths through which sound waves W1 emitted from loudspeaker 2 pass increase with increasing proximity to the center of second partition plates 12 along second direction d2 where the number of second partition plates 12 that overlap is large, and decrease with increasing proximity to end portions of second partition plates 12 along second direction d2 (the right end and the left end in FIG. 7) where the number of second partition plates 12 that overlap is small. Accordingly, the wavefront of sound waves W1 can be virtually considered as a recessed wavefront as indicated by the dash-dotted line in FIG. 7.

With this, acoustic lens 1B produces such an advantageous effect that sound waves W1 are focused at virtual point p as if electric waves are focused at a focal point using a parabola antenna. Accordingly, since the sound pressure level of sound waves W1 increases at virtual point p on the central axis of acoustic lens 1B and is suppressed at a location off the central axis, the directivity of sound waves W1 is directed toward the center of second partition plates 12 along second direction d2. As described above, acoustic lens 1B according to Variation 2 has an advantage that the directivity of sound waves W1 (the directivity of sound waves W1 in second direction d2 in this case) is easily controlled by making the lengths of the plurality of second partition plates 12 aligned apart from each other in the traveling direction of sound waves W1 mutually different.

In Variation 2, with second direction d2 defined as a vertical direction, acoustic lens 1B is capable of controlling the directivity of sound waves W1 in the vertical direction. Therefore, acoustic lens 1B according to Variation 2 and loudspeaker system 100 that uses acoustic lens 1B may overcome the problems that loudspeaker system 200 according to the comparative example has.

For example, as is the case of the usage example illustrated in FIG. 2, loudspeaker system 100 that uses acoustic lens 1B is disposed in the vicinity of the left ear and in the vicinity of the right ear of user U1 seated on seat 3. In this case, since sound waves W1 emitted from loudspeaker 2 are emitted via acoustic lens 1B so that the directivity of sound waves W1 is directed toward the front of user U1 without being scattered in the vertical direction, sound waves W1 are unlikely to come behind seat 3 and sounds are unlikely to leak to a user seated on the seat behind seat 3.

In acoustic lens 1B according to Variation 2, as is the case of Variation 1, the opening ratios of first partition plates 11 may decrease with increasing distance from loudspeaker 2 in the traveling direction of sound waves W1. Likewise, the opening ratios of second partition plates 12 may decrease with increasing distance from loudspeaker 2 in the traveling direction of sound waves W1. The opening ratio of second partition plate 12 is defined by the ratio of the total area of holes 120 to the area of second partition plate 12 in any second partition plate 12. This configuration provides an advantage that the directivity of sound waves W1 is likely to be sharp compared with when the opening ratios of first partition plates 11 and the opening ratios of second partition plates 12 are not changed.

### Variation 3

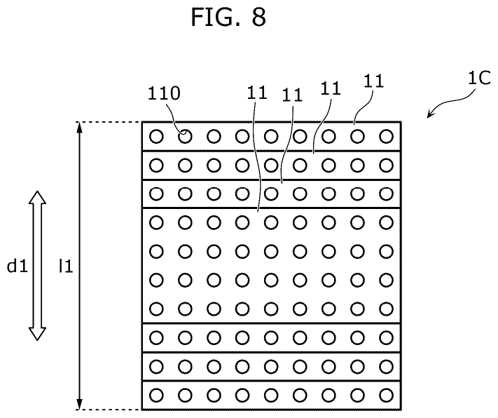

FIG. 8 is an overview diagram illustrating the configuration of acoustic lens 1C according to Variation 3 of the embodiment. Acoustic lens 1C according to Variation 3 differs from acoustic lens 1 according to the embodiment in that first direction d1 is defined as a vertical direction and a plurality of first partition plates 11 are disposed such that the number of the plurality of first partition plates 11 that overlap in the traveling direction of sound waves W1 decreases with increasing distance from the center of the plurality of first partition plates 11 along first direction d1. In other words, acoustic lens 1C according to Variation 3 is configured to mainly control the directivity of sound waves W1 in the vertical direction of sound waves W1, which is different from acoustic lens 1 according to the embodiment that is configured to mainly control the directivity of sound waves W1 in the horizontal direction of sound waves W1.

Specifically, in Variation 3, lengths l1 of the plurality of first partition plates 11 in first direction d1 are mutually different, as illustrated in FIG. 8. The plurality of first partition plates 11 are disposed such that the number of the plurality of first partition plates 11 that overlap in the traveling direction of sound waves W1 decreases with increasing distance from the center of the plurality of first partition plates 11 along first direction d1. Stated differently, the plurality of first partition plates 11 are disposed such that the number of the plurality of first partition plates 11 that overlap in the traveling direction of sound waves W1 monotonically increases toward one end of the plurality of first partition plates 11 along first direction d1 closer to the directivity of sound waves W1 that is desired to be set. In other words, the plurality of first partition plates 11 are disposed such that lengths l1 of the plurality of first partition plates 1 in first direction d1 increase with increasing distance from loudspeaker 2 in the traveling direction of sound waves W1. That is to say, among the plurality of first partition plates 11, length l1 of first partition plate 11 in first direction d1 that is located closest to loudspeaker 2 in the traveling direction of sound waves W1 is the shortest and length l1 of first partition plate 11 in first direction d1 that is located farthest from loudspeaker 2 in the traveling direction of sound waves W1 is the longest.

As described above, in Variation 3, with first direction d1 defined as a vertical direction, acoustic lens 1C is capable of controlling the directivity of sound waves W1 in the vertical direction.

In acoustic lens 1C according to Variation 3, as is the case of Variation 1, the opening ratios of first partition plates 11 may decrease with increasing distance from loudspeaker 2 in the traveling direction of sound waves W1. This configuration provides an advantage that the directivity of sound waves W1 is likely to be sharp compared with when the opening ratios of first partition plates 11 are not changed.

### Other Embodiments

In the embodiment and each of the variations, holes 110 and 120 that are adjacent to each other in the traveling direction of sound waves W1 may be disposed not to overlap each other when viewed along the traveling direction of sound waves W1. Stated differently, at least one or more holes 110 and one or more holes 120 need not overlap each other when viewed along the traveling direction of sound waves W1. This configuration provides an advantage that the directivity of sound waves W1 is likely to be sharp since the lengths of paths through which sound waves W1 pass can be increased.

In the embodiment and each of the variations, the plan view shape of holes 110 and 120 is not limited to circular and may be, for example, rectangular or polygonal.

Other embodiments obtained by various modifications to the embodiments which may be conceived by those skilled in the art, and embodiments achieved by combining elements and functions described in each of the embodiments are also included in the scope of the present disclosure so long as they do not depart from the essence of the present disclosure.

### INDUSTRIAL APPLICABILITY

The present disclosure is useful as a member that controls the directivity of sound waves emitted from a loudspeaker.

1. An acoustic lens comprising:
a plurality of first partition plates aligned apart from each other in a traveling direction of a sound wave to be emitted from a loudspeaker, wherein
each of the plurality of first partition plates includes holes through which the sound wave passes, and
lengths of the plurality of first partition plates in a first direction are mutually different.

2. The acoustic lens according to claim 1, wherein
the plurality of first partition plates are disposed such that a total number of the plurality of first partition plates that overlap in the traveling direction of the sound wave monotonically decreases from one end of the plurality of first partition plates to an other end in the first direction.

3. The acoustic lens according to claim 1, further comprising:
a plurality of second partition plates that overlap the plurality of first partition plates in the traveling direction of the sound wave and are aligned apart from each other, wherein
each of the plurality of second partition plates has holes through which the sound wave passes, and
lengths of the plurality of second partition plates in a second direction are mutually different, the second direction intersecting the first direction.

4. The acoustic lens according to claim 3, wherein
the plurality of second partition plates are disposed such that a total number of the plurality of second partition plates that overlap monotonically decreases in the traveling direction of the sound wave with increasing distance from a center of the plurality of second partition plates along the second direction.

5. The acoustic lens according to claim 3, wherein
the first direction and the second direction are orthogonal to each other.

6. The acoustic lens according to claim 1, wherein
diameters of the holes decrease in the traveling direction of the sound wave with increasing distance from the loudspeaker.

7. The acoustic lens according to claim 1, wherein
at least one or more of the holes do not overlap each other in the traveling direction of the sound wave.

8. A loudspeaker system comprising:
the acoustic lens according to claim 1; and
the loudspeaker that emits the sound wave to the acoustic lens.
